(19) United States
(12) Patent Application Publication
(10) Pub. No.: US 2002/0083600 A1
(43) Pub. Date: Jul. 4, 2002

(54) Safety razor

(76) Inventor: James A. Donovan, Odessa, FL (US)

Correspondence Address: John S. Munday, Esquire, Law Offices of John S. Munday, PO Box 423, Isanti, MN, 55040, US

(21) Appl. No.: 10/023,367

(22) Filed: Dec. 18, 2001

Related U.S. Application Data
(60) Provisional application No. 60/259,153, filed on Dec. 29, 2000.

(51) Int. Cl. B26B 21/14; B26B 21/52

(52) U.S. Cl. 30/526; 30/32; 30/539

(57) ABSTRACT

A safety razor device including a blade unit with at least one small blade has been fixedly mounted for presenting a whisker cutting edge. The blade unit is fixedly attached to a handle. Also included is a blade guard, which defines a skin contacting surface to establish a “shaving geometry” to define the parameters which determine the blade orientation and position relative to the skin. A clear head covers the razor when not in use without preventing determination if a blade has been removed. Also provided is a short handle, of relatively flexible or resilient material to increase traction force on the skin surface being shaved and yet not provide a component that can be used as a weapon.

### FIELD OF THE INVENTION

This invention relates to a safety razor. More particularly, the invention relates to a safety razor with a single blade encased in a clear frame for visual inspection and monitoring, particularly in security systems such as jails, prisons and the like.

### BACKGROUND OF THE INVENTION

One of the main problems in security systems such as jails, prisons and detention centers is the need to provide hygienic conditions without giving the inmates an opportunity to do violence to others or themselves. This is particularly true in men's confinement where the daily need to shave has to be balanced with the potential that a razor has as a weapon.

In minimum security facilities, inmates are relatively trustworthy and not prone to violence with one another, but the concern still exists since those in prison often act out with unpredictable behavior. In more strict confinement, extreme caution must be exercised to prevent, as much as possible, those who are incarcerated from being given any object which can be turned into a weapon. Again, while shaving is a basic need of most men, at least at their own option, and while a clean shaved face assists correction officers from being certain in their identification of various inmates, the use of a razor represents a serious concern for all.

In prior efforts at disposable razors, such as those sold in commercial markets to ordinary citizens, the blade is sufficiently large to present a dangerous weapon when removed from the razor and attached to another device or handle. Inspection of these razors by guards or safety personnel is difficult and time consuming, and therefore often does not get done in a proper manner. Because of the use of opaque plastics, many commercially available razors are not easily inspectable, even under the most vigilant eyes. Moreover, present day disposable razors are formed form hard plastic, so that the stem itself becomes a weapon, where an angry or hostile inmate might hold the razor by the head and jab at another inmate with the handle end. The handle becomes even more dangerous when the end is sharpened, such as by grinding on a cement wall or floor.

It would be a great advantage to the correction system if an improved safety razor could be developed that would be easily inspected, and not permit removal of the blade without such removal destroying the device and, also, being clearly observable from a safe distance.

It is therefore an object of this invention to provide safety razor that is usable by inmates in a prison or other confined facility without giving the user a device that can be converted into a dangerous weapon.

Another object is to provide a safety razor design that permits relatively easy and accurate inspection by officials of a facility.

Yet another object of the present invention is to provide a safety razor of disposable construction and low cost which allows a good, close shave without the use of hard materials.

Other objects will appear hereinafter.

### SUMMARY OF THE INVENTION

It has now been discovered that the above and other objects of the present invention may be accomplished in the following manner. The unique aspect of this invention is the use of a compact design to construct a safety razor using one blade installed in the razor so that removal of the blade destroys the razor and is clearly obvious by inspection at a reasonable distance, such as from outside a prison cell when an inmate is requested to show the device to a guard.

The safety razor device of this invention includes a blade unit in which a thin, small razor blade has been fixedly mounted to provide one blade for presenting a whisker cutting edge that is moved across the skin being shaved. The blade unit is fixedly attached to a handle.

Because the blade unit is permanently mounted on the handle, the use and handling of the razor is enhanced. The razor of this invention is designed to be discarded when the blade becomes dull or unsatisfactory.

Also included is a blade guard, which defines a surface for contacting the skin in front of the blade or blades. It is an optional embodiment to use two blades for a closer shave. The guard establishes a “shaving geometry” to define the parameters which determine the blade orientation and position relative to the skin during shaving.

The device includes a clear head for covering the razor when not in use without preventing determination if a blade has been removed, thus allowing for visual inspection at a reasonable distance from the user.

As will be appreciated, the razor of this invention has a short handle portion, of relatively flexible or resilient material, to increase traction force on the skin surface being shaved and yet not provide a component that can be used as a weapon.

### BRIEF DESCRIPTION OF THE DRAWINGS

For a more complete understanding of the invention, reference is hereby made to the drawings, in which:

FIG. 1 is a front elevational view of the preferred embodiment of the invention;

FIG. 2 is a plan view of a removable portion of the device shown in FIG. 1;

FIG. 3 is a back elevational view of the device shown in FIG. 1;

FIG. 4 is a plan view of a removable portion of the device shown in FIG. 3; and

FIG. 5 is a side elevational view of the device shown in FIG. 1.

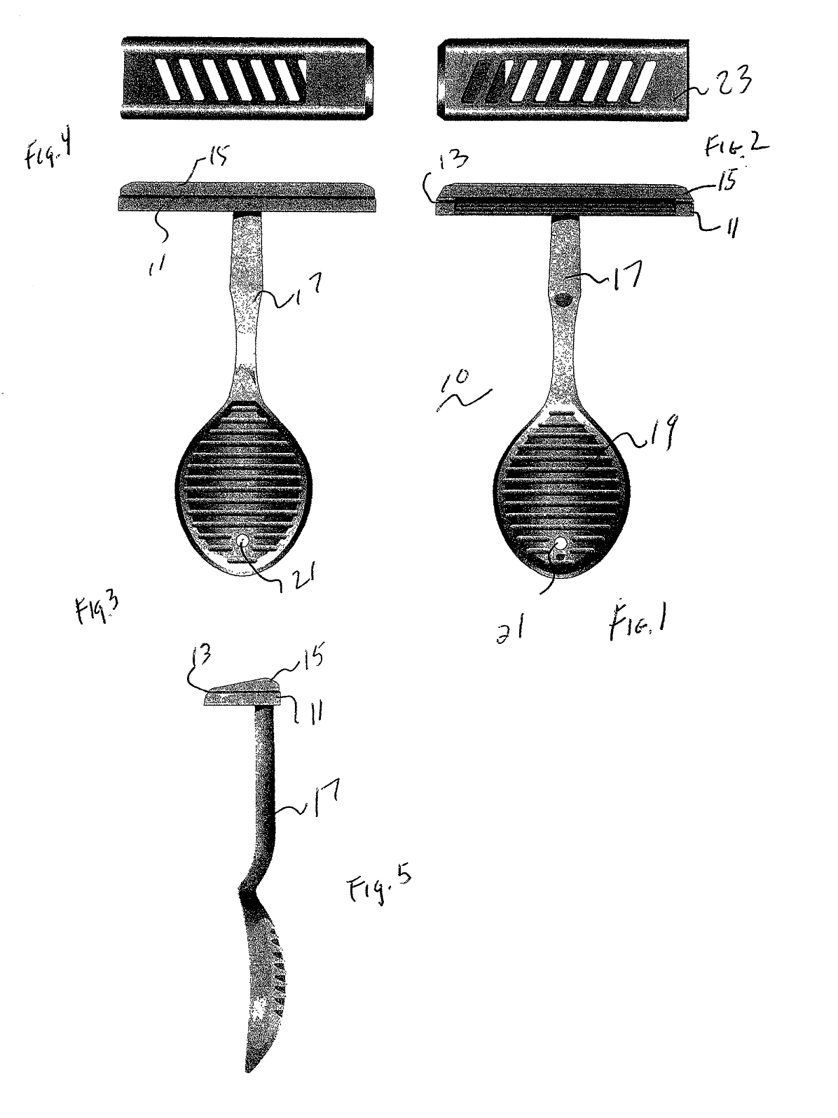

### DETAILED DESCRIPTION OF THE PREFERRED EMBODIMENT

As shown in the figures, the device 10 is a safety razor having a lower blade unit portion 11, onto which blade 13 is permanently and fixedly mounted via upper blade unit portion 15, forming a complete blade unit from which the blade 13 cannot be removed without destroying the unit Preferably the unit is made from plastic that can be easily molded and sealed by heat or other means after the blade has been installed.

The lower blade unit 11 is fixedly and permanently attached to the handle portion 17, which is flared and expanded at its lower portion 19. Lower portion 19 of handle 17 may include a hole 21 at its distal end, for hanging the device to dry in air when stored. The razor also includes a clear head 23 that removeably covers the blade unit when not in use, and permits inspection of the device to verify that the blade has not been removed FIG. 5 illustrates the tapered upper blade unit for defining a proper angle for contact between the blade and the skin being shaved

The razor of the present invention is admirably suited for use in prisons, jails and other security facilities. The clear head permits verification of the integrity of the device. The sealed head prevents the head from being opened and the blade removed or repositioned as a weapon. The handle and the beaver tail eliminates the potential for sharpening that end to form it into a weapon, being too flexible to be used to stab someone. The beaver tail also assists in giving a good shave by being flexible enough to exert traction on the face.

In a preferred embodiment, the device is made from bright orange died plastic, or other highly visible colors, to enhance the visibility for guards in prisons.

While particular embodiments of the present invention have been illustrated and described, it is not intended to limit the invention to any specific embodiment. The dimensions and materials given are for the preferred embodiment and are not to be construed as limitations on the scope of this invention. The description of the invention is not intended to limit the invention.

1. A safety razor device comprising:
a blade unit
at least one thin, small blade having a cutting edge fixedly mounted to said blade unit for presenting a whisker cutting edge to the skin being shaved;
a handle fixedly attached to said blade unit; and
a blade guard covering said blade and defining a surface for contacting the skin in front of said at least one blade.

2. The device of claim 1, wherein said at least one blade comprises a pair of parallel blades

3. The device of claim 2, wherein said guard and blades establishes a shaving geometry to define the parameters which determine the blade orientation and position relative a user's skin during shaving.

4. The device of claim 1, which further includes a clear head for covering the razor when not in use without preventing determination if a blade has been removed for allowing for visual inspection at a reasonable distance from the user.

5. The device of claim 1, wherein said handle is short and of flexible material to increase traction force on the skin surface being shaved while providing a component too flexible for use as a weapon.

6. A safety razor device comprising:
blade unit means for holding a razor blade;
blade means for providing at least one thin, small blade fixedly mounted to said blade unit means for presenting a whisker cutting edge to the skin being shaved;
handle means fixedly attached to said blade unit means for directing the blade means on said skin; and
blade guard means for covering said blade means and defining a surface for contacting the skin in front of said blade means.

7. The device of claim 6, wherein said blade means comprises a pair of parallel blades

8. The device of claim 7, wherein said guard means and blade means establishes a shaving geometry to define the parameters which determine the blade means orientation and position relative a user's skin during shaving.

9. The device of claim 6, which further includes clear head means for covering said blade means when not in use without preventing determination if said at least one blade has been removed for allowing for visual inspection at a reasonable distance from the user.

10. The device of claim 6, wherein said handle means is short and of flexible material to increase traction force on the skin surface being shaved while providing a component too flexible for use as a weapon.

11. A safety razor device comprising:
a blade unit
at least one thin, small blade having a cutting edge fixedly mounted to said blade unit for presenting a whisker cutting edge to the skin being shaved;
a handle fixedly attached to said blade unit, said handle being short and of flexible material to increase traction force on the skin surface being shaved while providing a component too flexible for use as a weapon;
a blade guard covering said blade and defining a surface for contacting the skin in front of said at least one blade, said guard and blades establishing a shaving geometry to define the parameters which determine the blade orientation and position relative a user's skin during shaving; and
a clear head for covering said blade when not in use without preventing determination if said at least one blade has been removed for allowing for visual inspection at a reasonable distance from the user.

12. The device of claim 11, wherein said at least one blade comprises a pair of parallel blades
